(19) United States
(12) Patent Application Publication
(10) Pub. No.: US 2024/0086222 A1
(43) Pub. Date: Mar. 14, 2024

(54) METHOD TO MANAGE A HYPER-CONVERGED INFRASTRUCTURE WITH A DESIRED STATE MODEL

(71) Applicant: DELL PRODUCTS L.P., Round Rock, TX (US)

(72) Inventors: Xueqiang Zhou, Shanghai (CN); Zhenyu Qi, Shanghai (CN); Zhe Huang, Suzhou (CN); Raul Lvjia Lao, Shanghai (CN)

(73) Assignee: DELL PRODUCTS L.P., Round Rock, TX (US)

(21) Appl. No.: 17/949,533

(22) Filed: Sep. 21, 2022

(30) Foreign Application Priority Data
Sep. 8, 2022 (CN) 202211098692.9

(51) Int. Cl. G06F 9/455

(52) U.S. Cl. CPC G06F 9/45558; G06F 2009/45562

(57) ABSTRACT

A system for processing data, comprising a virtual environment management system operating on a processor and configured to retrieve a predefined virtual computer desired state first plurality of hardware components and a first plurality of software components, a virtual computer operating on the processor and configured to provide a user-defined desired state for a second plurality of hardware components and a second plurality of software components and wherein the virtual environment management system is configured to compare the first plurality of hardware components and the first plurality of software components with the second plurality of hardware components and the second plurality of software components and to modify the predefined virtual computer desired state if there are any differences between the first plurality of hardware components and the first plurality of software components with the second plurality of hardware components and the second plurality of software components.

### TECHNICAL FIELD

The present disclosure relates generally to data processing systems, and more specifically to a method for managing a hyper-converged infrastructure (HCI) with a virtual computer desired state model.

### BACKGROUND OF THE INVENTION

Computing systems are complex combinations of hardware and software, and there are many ways in which those systems can be configured to operate. As a result, there are often incompatibilities between hardware and software that can prevent operation.

### SUMMARY OF THE INVENTION

A system for processing data is disclosed that includes a virtual environment management system operating on a processor that retrieves a predefined desired state for a first plurality of hardware components and a first plurality of software components. A virtual computer operating on the processor is configured to provide a user-defined virtual computer desired state for a second plurality of hardware components and a second plurality of software components. The virtual environment management system is configured to compare the first plurality of hardware components and the first plurality of software components with the second plurality of hardware components and the second plurality of software components and to modify the predefined virtual computer desired state if there are any differences between the first plurality of hardware components and the first plurality of software components with the second plurality of hardware components and the second plurality of software components.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a diagram of a system for providing virtual computer desired state management, in accordance with an example embodiment of the present disclosure;

FIG. 2 is a diagram of an algorithm for providing virtual computer desired state management, in accordance with an example embodiment of the present disclosure;

FIG. 3 is a diagram of an algorithm for target processing, in accordance with an example embodiment of the present disclosure;

FIG. 4 is a diagram of an algorithm for merging existing states with new virtual computer desired states, in accordance with an example embodiment of the present disclosure; and

FIGS. 5 through 7 are diagrams showing a process for managing a virtual computing environment, in accordance with an example embodiment of the present disclosure.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

A virtual machine (VM) is an emulation of a computer system that can be created on an as-needed basis for specific applications or other suitable purposes. In order to support the VM application model for network architectures, specialized hardware platforms that run VM-compatible software can be provided. One example of such a platform is hyper-converged infrastructure (HCI), which can include a software-defined, unified system that combines all the elements of a traditional data center, such as storage, computation power, networking and systems management.

The present disclosure relates to an HCI innovation that provides a qualified and certified combination of hardware and software that has been configured to allow a user to quickly implement an HCI. A virtual environment management system can be used for computing cluster management, where a computing cluster is a group of independent processors that are configured to operate in conjunction with each other to provide predetermined services. The configuration of a computing cluster can be referred to a virtual computer desired state based management. The HCI can be adapted for use with a virtual environment management system to provide a simplified user experience and to control the combination of hardware and software to implement the virtual computer desired state based model.

There may be only one virtual computer desired state for a virtual environment management system, but a user can change the configuration of a cluster so that it does not match with the virtual computer desired state. The present disclosure provides systems and methods for identifying these non-compliant configurations and adapting them to the virtual environment management system.

The virtual environment management system does not need to manage everything in the cluster environment. For example, the virtual environment management system is not required to manage networking protocols, graphics processing unit (GPU) drivers or other systems and components. The user typically relies on the virtual environment management system embedded capability to manage the virtual computer desired state.

The user may want to implement a customization based on a virtual environment management system pre-defined virtual computer desired state. For example, the user may want to use a different version of host bus adapter (HBA) driver than the virtual environment management system provided HBA driver. The virtual environment management system of the present disclosure is configured to manage the virtual computer desired state when some components are controlled by virtual environment management system and other components are controlled by the user or HCI.

In one example embodiment, the present disclosure provides runtime detection of non-compliant cluster configurations and generates a user interface control that allows a user to select a specific function, such as:
1. After a target virtual computer desired state is set up, a user can make adjustments, such as:
a) The user may go to a virtual computer (VC) user interface control that is configured to allow the user to modify the virtual computer desired state on the VC.
b) The user can access a user control to allow the user to pin, add, change or delete hardware or software that is different from the current virtual computer desired state.

The present disclosure provides a runtime background process that can detect any changes and conform them to the virtual environment management system. In one example embodiment, the present disclosure allows a user to upgrade the HCI with a new pre-defined virtual computer desired state.
1. When implementing an upgrade, the virtual environment management system can first try to introduce the upgrade with a new pre-defined virtual computer desired state
2. The virtual environment management system can merge the new virtual computer desired state with any user-provided virtual computer desired state modifications and exclude list entries (configurations that should be excluded).
3. The virtual environment management system is configured to detect these conditions automatically and to accommodate any changes made by the user, such as:
a) Components added by the user,
b) Components with attributes that are fixed or pinned by the user; and
c) Components excluded by the user.

Additional details regarding the functions that are performed by hardware operating under algorithmic control are provide in the example embodiments disclosed herein. It is noted that the current approach to resolving these problems is to rely on the user to manually manage the virtual computer desired state, which quite costly and error-prone.

The systems and methods of the present disclosure can be used to combine prescribed configurations with user customizations into a single virtual computer desired state. The user customization can be retained for use in future hardware and software upgrades without having to repeat the same customization process. The present disclosure provides for a pre-check of the compatibility of the combined virtual computer desired state, and can provide an indication to a user on how to fix any non-compatibility.

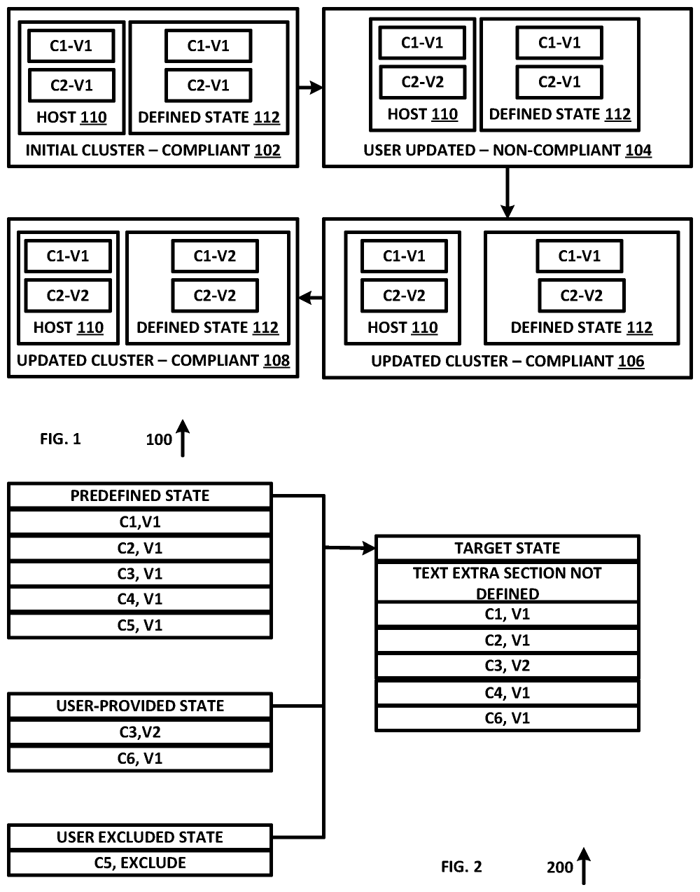

FIG. 1 is a diagram of a system 100 for providing virtual computer desired state management, in accordance with an example embodiment of the present disclosure. System 100 can be implemented in hardware or a suitable combination of hardware and software.

System 100 includes initial cluster-compliant 102, which can be implemented in hardware or a suitable combination of hardware and software. A compliant initial cluster configuration is shown with a host processor that has component 1 with version 1 of software and component 2 with version 1 of software. This configuration matches a defined virtual computer desired state that has component 1 with version 1 of software and component 2 with version 1 of software.

System 100 further includes user updated-noncompliant 104 shows that a user has installed a non-compliant version 2 of the software for component 2. This user-modified state is an indication of a virtual computer desired state for the user that is different from the defined virtual computer desired state.

System 100 further includes updated cluster-compliant 106, which shows that the non-compliant version 2 of the software for component 2 has been added to defined virtual computer desired states. This state is used to modify the virtual computer desired state to accommodate the modifications that have been implemented by the user. In one example embodiment, the removal of version of the software for component 2 can also be flagged for disposition.

System 100 also includes updated cluster-compliant 108, which shows an updated host and matching defined state. The systems and methods disclosed herein implement the user virtual computer desired state into updated cluster-compliant 108, to allow the user virtual computer desired state to be maintained and implemented in future versions of initial cluster-compliant 102.

In operation, system 100 shows state changes that allow a user to implement a virtual computer desired state that includes user modifications that are different from a system virtual computer desired state. System 100 further provides for compatibility with subsequent versions of the system virtual computer desired state with the user virtual computer desired state.

FIG. 2 is a diagram of an algorithm 200 for providing virtual computer desired state management, in accordance with an example embodiment of the present disclosure. Algorithm 200 can be implemented in hardware or a suitable combination of hardware and software.

Algorithm 200 includes a predefined state that has components 1 through 5, each with version 1 of associated software that is used with components 1 through 5, such as to load algorithms embodied in the software into a data memory device of the components to cause hardware systems of the components to perform predetermined functions.

User-provided state of algorithm 200 includes component 3 with version 2 of software, and a new component 6 with version 1 of software. The user-provided state reflects changes made by a user to provide a user virtual computer desired state, which are not provided for or accommodated by the predefined state. In addition, a user-excluded state for component 5 has been implemented.

The target state of algorithm 200 includes components 1, 2, 4 and 6 with version 1 of software, component 3 with version 2. The target state is generated using one or more algorithmic processes, such as those described in greater detail herein. The text of the extra section that is not defined is also provided to facilitate trouble-shooting or any other functions that require text.

In operation, algorithm 200 provides virtual computer desired state management by allowing a user to alter predetermined configurations of equipment in an HCI environment. While algorithm 200 is shown as a flow chart, a person of skill in the art will recognize that algorithm 200 can also or alternatively be implemented using object-orient programming, state diagrams, ladder diagrams, other suitable programming paradigms or a suitable combination of programming paradigms.

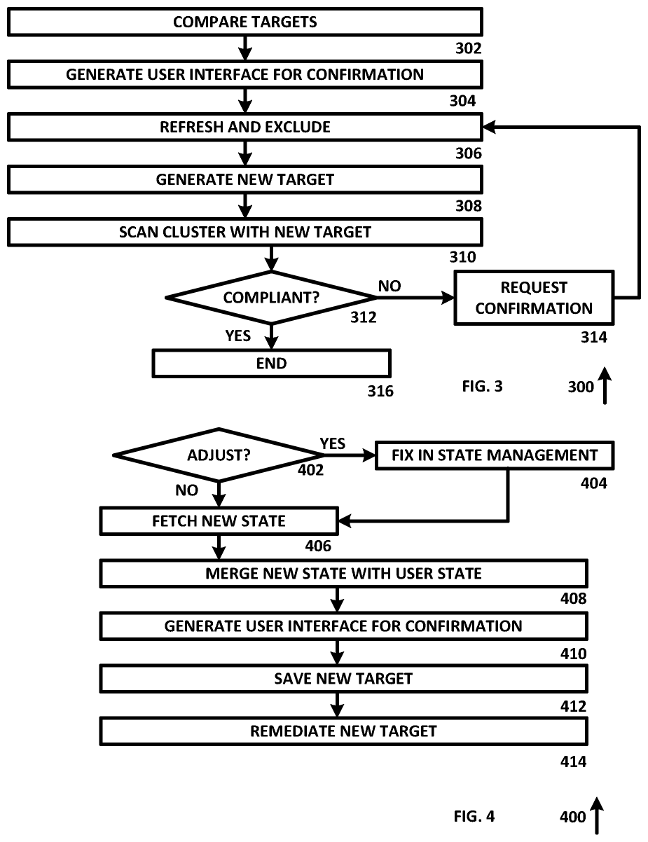

FIG. 3 is a diagram of an algorithm 300 for target processing, in accordance with an example embodiment of the present disclosure. Algorithm 300 can be implemented in hardware or a suitable combination of hardware and software.

Algorithm 300 begins at 302, where a target state on a virtual environment management system and a virtual computer are compared. In one example embodiment, a processor can function under algorithmic control to retrieve target definition data from the virtual environment management system and the virtual computer and can compare the target definition data, or other suitable processes can also or alternatively be used. The algorithm then proceeds to 304.

At 304, a user interface is generated for confirmation that there are no differences or that any differences are intended. In one example embodiment, user controls can be generated to allow the user to accept the differences, make changes, reject the differences or to perform other suitable functions. The algorithm then proceeds to 306.

At 306, a user-provided virtual computer desired state and exclude list is refreshed. In one example embodiment, the user-provided virtual computer desired state and exclude list can be modified in response to user controls selected by the user or in other suitable manners. The algorithm then proceeds to 308.

At 308, a new target virtual computer desired state is generated for the virtual environment management system and the virtual computer. The algorithm then proceeds to 310.

At 310, a computing cluster is scanned using the new target virtual computer desired states. The algorithm then proceeds to 312.

At 312, it is determined whether the new cluster is compliant with the new target virtual computer desired states. If it is determined that the new cluster is not compliant, the algorithm proceeds to 314, where the compliant portions of any target virtual computer desired states in the cluster are implemented and confirmation is requested for any remaining changes. The algorithm then returns to 306. Otherwise, the algorithm proceeds to 316 and ends.

In operation, algorithm 300 provides target processing for virtual computer desired state management by allowing a user to identify targets in an HCI environment. While algorithm 300 is shown as a flow chart, a person of skill in the art will recognize that algorithm 300 can also or alternatively be implemented using object-orient programming, state diagrams, ladder diagrams, other suitable programming paradigms or a suitable combination of programming paradigms.

FIG. 4 is a diagram of an algorithm 400 for merging existing states with new virtual computer desired states, in accordance with an example embodiment of the present disclosure. Algorithm 400 can be implemented in hardware or a suitable combination of hardware and software. Before refreshing a pre-defined virtual computer desired state, the target virtual computer desired state in a virtual environment management system and a virtual computer should be same, and the cluster should be compliant with the target virtual computer desired state in the virtual computer, such as by using algorithm 300 or in other suitable manners.

Algorithm 400 begins are 402, where it is determined whether a runtime virtual computer desired state adjustment is required. If it is determined that an adjustment is required, the algorithm proceeds to 404, where the adjustment is fixed in runtime virtual computer desired state management process, and the algorithm then proceeds to 406. Otherwise, the algorithm proceeds directly to 406, where a new predefined virtual computer desired state is fetched. The algorithm then proceeds to 408.

At 408, the new predefined virtual computer desired state is merged with the user-defined virtual computer desired state. The algorithm then proceeds to 410.

At 410, a user interface is generated to require the user to confirm that the merged states are correct, to make any adjustments that may be required or to perform other suitable functions. The algorithm then proceeds to 412.

At 412, the new target virtual computer desired state is saved in both the virtual environment management system and the virtual computer. The algorithm then proceeds to 414.

At 414, the cluster is remediated with the new target virtual computer desired state and the algorithm terminates.

In operation, algorithm 400 provides virtual computer desired state management by allowing a user to merge existing modifications with predetermined configurations of equipment in an HCI environment. While algorithm 400 is shown as a flow chart, a person of skill in the art will recognize that algorithm 400 can also or alternatively be implemented using object-orient programming, state diagrams, ladder diagrams, other suitable programming paradigms or a suitable combination of programming paradigms.

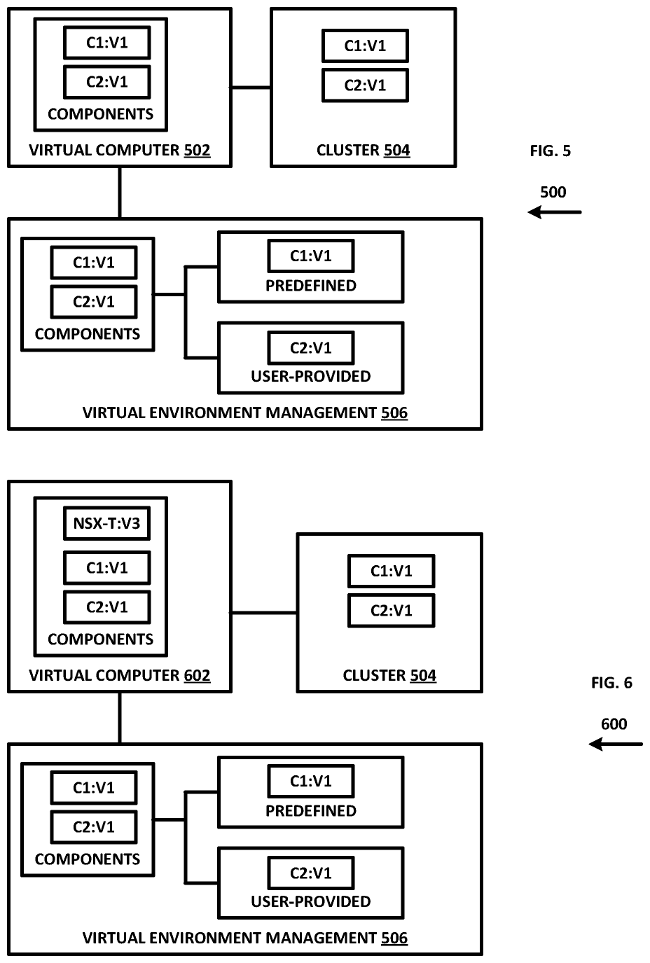

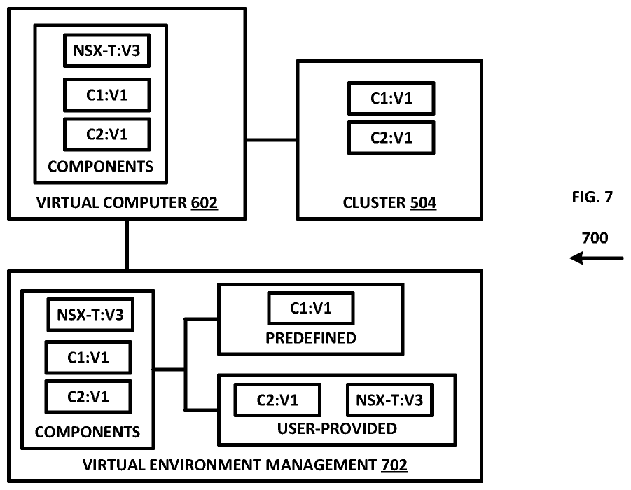

FIGS. 5 through 7 are diagrams 500, 600 and 700, respectively, showing a process for managing a virtual computing environment, in accordance with an example embodiment of the present disclosure. The systems shown in diagrams 500, 600 and 700 can be implemented in hardware or a suitable combination of hardware and software.

Diagram 500 includes virtual computer 502, cluster 504 and virtual environment management 506. Virtual environment management 506 includes user-provided and predefined components.

Diagram 600 includes virtual computer 602 (which includes networking and security platform NSX-T with version 3 of associated software), cluster 504 and virtual environment management 506.

Diagram 700 includes virtual computer 602, cluster 504 and virtual environment management 702, which has been remediated with virtual computer 602. In this manner, the virtual computer desired states for virtual computer 602 and virtual environment management 702 are the same.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. A software system is typically created as an algorithmic source code by a human programmer, and the source code algorithm is then compiled into a machine language algorithm with the source code algorithm functions, and linked to the specific input/output devices, dynamic link libraries and other specific hardware and software components of a processor, which converts the processor from a general purpose processor into a specific purpose processor. This well-known process for implementing an algorithm using a processor should require no explanation for one of even rudimentary skill in the art. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. A system can receive one or more data inputs, such as data fields, user-entered data, control data in response to a user prompt or other suitable data, and can determine an action to take based on an algorithm, such as to proceed to a next algorithmic step if data is received, to repeat a prompt if data is not received, to perform a mathematical operation on two data fields, to sort or display data fields or to perform other suitable well-known algorithmic functions. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for processing data, comprising:
a virtual environment management system operating on a processor and configured to retrieve a predefined virtual computer desired state for a first plurality of hardware components and a first plurality of software components;
a virtual computer operating on the processor and configured to provide a user-defined virtual computer desired state for a second plurality of hardware components and a second plurality of software components; and
wherein the virtual environment management system is configured to compare the first plurality of hardware components and the first plurality of software components with the second plurality of hardware components and the second plurality of software components and to modify the predefined virtual computer desired state if there are any differences between the first plurality of hardware components and the first plurality of software components with the second plurality of hardware components and the second plurality of software components.

2. The system of claim 1 wherein the virtual environment management system is configured to generate a user interface control to allow a user to confirm the modifications to the predefined virtual computer desired state prior to implementing the modifications to the predefined virtual computer desired state.

3. The system of claim 1 wherein the virtual environment management system is configured to generate a user interface control to allow a user to confirm an exclusion of a hardware component or a software component from the predefined virtual computer desired state prior to implementing the modifications to the predefined virtual computer desired state.

4. The system of claim 1 wherein the virtual environment management system is configured to generate a user interface control to allow a user to confirm the modifications to the predefined virtual computer desired state and an exclusion of a hardware component or a software component from the predefined virtual computer desired state prior to implementing the modifications to the predefined virtual computer desired state.

5. The system of claim 1 wherein the virtual environment management system is further configured to modify a computing cluster virtual computer desired state configuration.

6. The system of claim 1 wherein the virtual environment management system is configured to generate a user interface control to allow a user to confirm a modifications to a driver for the predefined virtual computer desired state prior to implementing the modifications to the driver for the predefined virtual computer desired state.

7. The system of claim 1 wherein the virtual environment management system is configured to generate a user interface control to allow a user to confirm a modifications to a host bus adapter driver for the predefined virtual computer desired state prior to implementing the modifications to the host bus adapter driver for the predefined virtual computer desired state.

8. The system of claim 1 wherein the virtual environment management system is further configured to scan a computing cluster to identify a non-compliant virtual computer desired state configuration.

9. The system of claim 8 wherein the virtual environment management system is further configured to modify a non-compliant computing cluster to remediate a virtual computer desired state configuration.

10. A method for processing data, comprising:
retrieving a predefined virtual computer desired state for a first plurality of hardware components and a first plurality of software components using a virtual environment management system operating on a processor;
storing a user-defined virtual computer desired state for a second plurality of hardware components and a second plurality of software components using a virtual computer operating on the processor; and
comparing the first plurality of hardware components and the first plurality of software components with the second plurality of hardware components and the second plurality of software components using the virtual environment management system; and
modifying the predefined virtual computer desired state if there are any differences between the first plurality of hardware components and the first plurality of software components with the second plurality of hardware components and the second plurality of software components.

11. The method of claim 10 further comprising generating a user interface control using the virtual environment management system to receive a user confirmation of the modifications to the predefined virtual computer desired state prior to implementing the modifications to the predefined virtual computer desired state.

12. The method of claim 10 further comprising generating a user interface control using the virtual environment management system to receive a user confirmation to exclude a hardware component or a software component from the predefined virtual computer desired state prior to implementing the modifications to the predefined virtual computer desired state.

13. The method of claim 10 further comprising generating a user interface control using the virtual environment management system to receive a confirmation that the modifications to the predefined virtual computer desired state and an exclusion of a hardware component or a software component from the predefined virtual computer desired state is approved prior to implementing the modifications to the predefined virtual computer desired state.

14. The method of claim 10 further comprising modifying a computing cluster virtual computer desired state configuration using the virtual environment management system.

15. The method of claim 10 further comprising generating a user interface control using the virtual environment management system to receive a user confirmation of modifications to a driver for the predefined virtual computer desired state prior to implementing the modifications to the driver for the predefined virtual computer desired state.

16. The method of claim 10 further comprising generating a user interface control using the virtual environment management system to receive a user confirmation of modifications to a host bus adapter driver for the predefined virtual computer desired state prior to implementing the modifications to the host bus adapter driver for the predefined virtual computer desired state.

17. The method of claim 10 further comprising scanning a computing cluster to identify a non-compliant virtual computer desired state configuration using the virtual environment management system.

18. The method of claim 17 further comprising modifying a non-compliant computing cluster to remediate a virtual computer desired state configuration using the virtual environment management system.
